(19) United States
(12) Patent Application Publication
(10) Pub. No.: US 2017/0307411 A1
(43) Pub. Date: Oct. 26, 2017

(54) POSITION SENSOR

(71) Applicant: KSR IP Holdings, LLC, Wilmington, DE (US)

(72) Inventor: Ryan W. Elliott, Chatham (CA)

(21) Appl. No.: 15/491,488

(22) Filed: Apr. 19, 2017

Related U.S. Application Data
(60) Provisional application No. 62/351,561, filed on Jun. 17, 2016.
(60) Provisional application No. 62/326,085, filed on Apr. 22, 2016.

(51) Int. Cl. G01D 5/20

(52) U.S. Cl. CPC G01D 5/204

(57) ABSTRACT

An inductive position sensor utilized with a rotating or linearly displacing electrically conductive component. In a first embodiment, a sensor housing is mounted to an exterior of a structure supporting the component and exhibits a radially inwardly extending printed circuit board (PCB) with sensor coils arrayed in spatial and non-contacting position relative to a cross sectional cam end surface profile of the rotating component, such that rotation of the cam surface profile causes a linear displacement of the conducting coupler along the coils to determine a positional change of the rotating component. A further embodiment reconfigures the PCB in a linear direction within the sensor housing relative to the proximately located and linearly displaceable component and in which the sensor determines a lateral shifting of the component apart from its rotation.

### CROSS-REFERENCE TO RELATED APPLICATIONS

This Application claims the benefit of U.S. Provisional Application 62/351,561 filed on Jun. 17, 2016. The 62/351,561 Application claims the benefit, of U.S. Provisional Application 62/326,085 filed on Apr. 22, 2016, the contents of which are incorporated in their entirety.

### FIELD OF THE INVENTION

The present invention is directed to a housing supported and electrically conductive component, such as in use with a vehicle transfer case and including either of a rotating component with a cross sectional cam profile or any rotating or non-rotating component which is linearly displaceable. Inductive sensor technology is employed for determining a change in position of the component

### BACKGROUND OF THE INVENTION

A transfer case receives power from the transmission of a vehicle and delivers it to both the front and rear axles. A driver can put the transfer case into either a two-wheel drive or four-wheel drive by means of a shifter similar to that in a manual transmission. Movement of the shifter rotates a cam inside the gearbox. Certain segments of the cam surface correlate with the selection the driver makes, for instance two-wheel drive or four-wheel drive. Currently, the position of the cam surface is determined by mechanical devices connected to the cam or by Hall effect sensors. Hall effect sensors have magnets attached to a cam which travel with the rotation with respect to sensors mounted inside the gearbox. It would be desirable to provide a position sensor which does not require components which are mounted to the cam or inside the transfer case.

### SUMMARY OF THE INVENTION

The present invention is an inductive position sensor utilized with a rotating or linearly displacing electrically conductive component, such as which is integrated into a structure not limited to a vehicle four wheel drive transfer case. In a first embodiment, a sensor housing is mounted to an exterior of the transfer case and exhibits a radially inwardly extending PCB with sensor coils arrayed in spatial and non-contacting position relative to a cross sectional cam end surface profile of the rotating component (such also referenced as an air gap separating the PCB from the electrically conductive coupler), with rotation of the cam surface profile causing a linear displacement along the coils to determine a positional change of the rotating component. A further embodiment of the inductive sensor reconfigures the PCB in a linear direction, such as within the sensor housing, relative to a proximately located and linearly displaceable component, not limited to a rotating or non-rotating locking collet, and in which the sensor determines a lateral shifting of the component (apart from any rotation) across the air gap separating the component from the sensor PCB.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an illustration of an inductive rotary cam position sensor according to a first embodiment of the present invention;

FIG. 2 is an enlarged view of a printed circuit board (PCB) according to one non-limiting construction exhibiting energizing and receiving coils aligned along a longitudinal axis which is integrated into the inductive sensor;

FIG. 3 is a graphical representation of rotational degrees, along an “x” axis, translated into linear units, along a “y axis”, corresponding to the rotational position or linear travel of the surface of the cam relative to the coils on the PCB;

FIGS. 4-5 illustrate first and second positions established by a rotating cam surface according to one construction and exhibiting discrete sections of arc positioned relative to a radially arrayed PCB extending within the housing and incorporated into the inductive position sensor in FIG. 1;

FIGS. 6-7 illustrate first and second positions of a further configured rotating cam surface, alternative to that presented in FIGS. 4-5, and which exhibits a non-discrete sloping cam surface relative to the position sensor;

FIG. 8 is an illustration of a position sensor according to a second embodiment incorporating a linearly arrayed PCB incorporated within the sensor housing for sensing a linear displacement of the interiorly supported and electrically conductive component;

FIG. 9 is an environmental perspective view of the position sensor of FIG. 8 mounted to a housing in the form of a vehicle transmission case housing enclosing an electrically conductive component in the form of an axle decoupling mechanism; and

FIG. 10 is an illustration of a discrete section of arc, such as which can be employed as a portion of the rotating cam surface of FIGS. 6-7 which converts rotation to linearly displacement along the PCB.

### DETAILED DESCRIPTION OF THE PREFERRED EMBODIMENTS

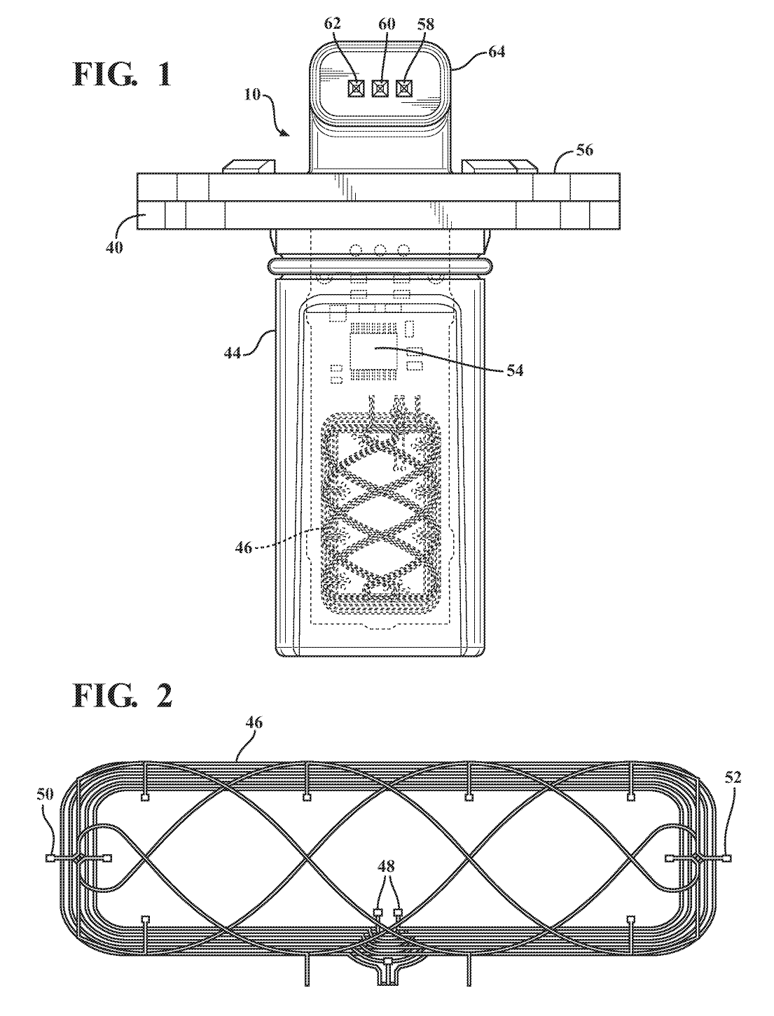

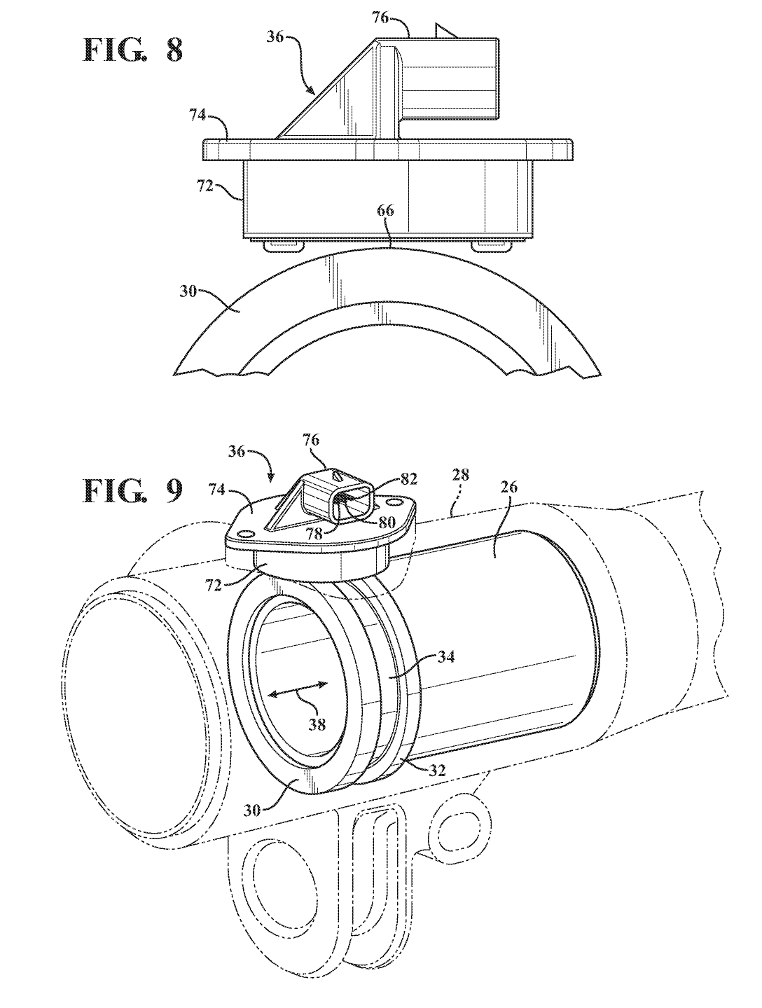

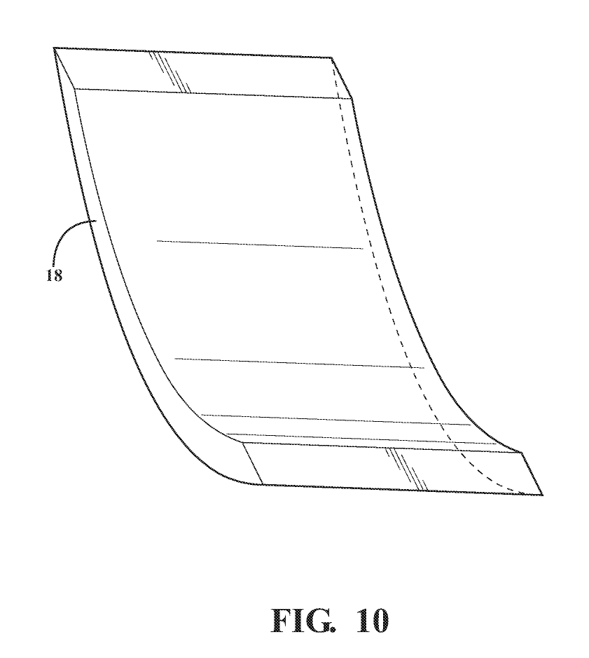

With reference to FIGS. 1-10, the present invention discloses position sensor utilizing inductive technology, and which can be utilized with either or both of rotating and/or linearly displacing electrically conductive components. As will be described in detail, a first embodiment of the sensor is depicted in FIG. 1 and exhibits a radially positioned PCB with sensor coils in spatial and non-contacting position relative to a cross sectional cam profile of an operative and rotating component (also referenced as an electrically conductive coupler). The rotating component in one application is incorporated into a four wheel drive transfer case. A further embodiment of sensor is depicted in FIGS. 8-9 and re-orients the PCB in a linear direction relative to a linearly displaceable component, such as a rotating or non-rotating locking collet, and in which the sensor determines lateral shifting of the electrically conductive component apart from its rotation.

Referring to FIG. 1, an illustration is generally shown at 10 of an inductive rotary cam position sensor (also termed a sensor module) according to a first embodiment of the present invention. As previously indicated, the sensor can be employed as a four-wheel drive transfer case cam position sensor that utilizes a cam as a coupler for an inductive linear position sensor.

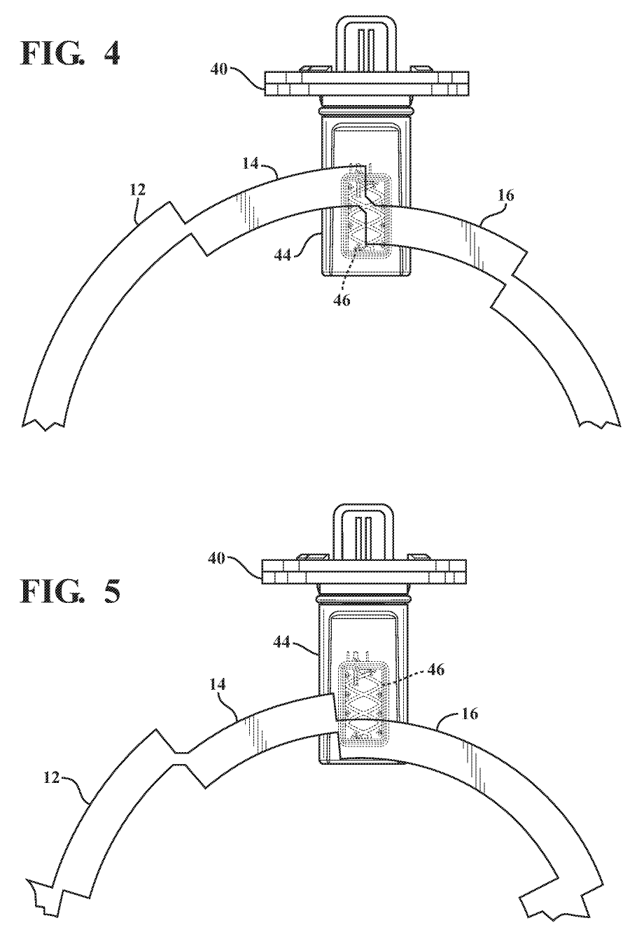

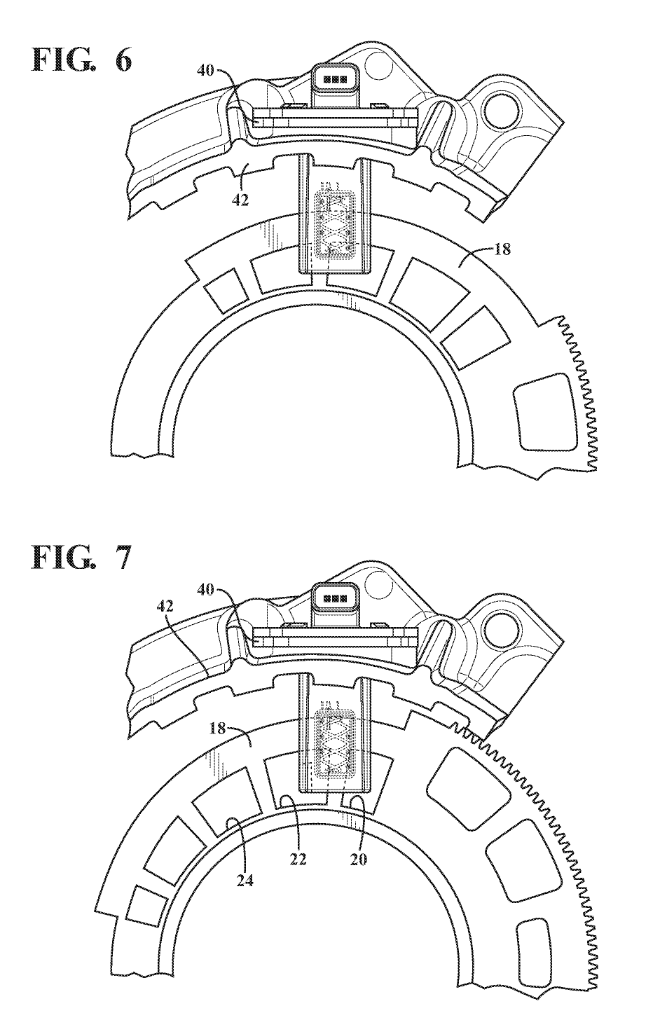

For purposes of the present description, the displacing and electrically conductive component (such as a grade steel) includes any type of existing or operational component integrated into the transfer case or other assembly and which can include a rotating component having a rotary displaceable cam shaped end profile. FIGS. 4-5 illustrate a first version of such a rotating component and in which the cam shaped profile is depicted as a stepped profile created by a plurality of discrete and successively offset sections of arc, such shown at 12, 14, 16, et seq. The ability to configure the cam surface formed of discrete sections of arc (12, 14, 16), results in each section having a fixed radius which is different from the adjacent segment to create a stepped type cam profile. Using the offset arc profile or stepped profile results in having discrete segments which increases the accuracy of the measurement. FIGS. 6-7 depict a further variant of cam shaped end profile exhibiting an outer sloping portion 18 of varying circumferential thickness, such being integrated in an operational component shown and which can also have windows or other apertures (see further at 20, 22, 24, et. seq.) for providing material savings and weight reduction.

In the further variant of FIGS. 8-9, the rotary component is reconfigured as an axle decoupling mechanism 26, such as which can rotate inside of an outer supporting structure 28 associated with the transfer case for shifting between two and four wheel drive configurations. The axle decoupling mechanism 26 is further shown with a pair of circumferentially extending and electrically conducting portions 30 and 32 separated by a drive finger engaging recess 34. For purposes of the variant of FIGS. 8-9, it is understood that only a single circumferential conducting portion 30 or 32 is necessary for the operation of the further variant of sensor module, depicted at 36 and in comparison to that depicted at 10 in FIG. 1.

It is also again understood that, while the component 26 can rotate (such as part of its intended operation), it is the lateral or linear shifting of the same relative to the outer transfer case 28 and proximately supported sensor module 36 which causes the inductive sensing. To this end, the embodiment of FIGS. 8-9 covers any rotating or non-rotating component which, at a minimum, can be shifted linearly as depicted by directional arrow 38 in FIG. 9.

Returning to the first embodiment of the sensor module (again at 10 in FIG. 1), a mounting portion 40 of the sensor module secures to a location of a structure 42 associated with a transfer case or other structure (compare to as shown at 28 in FIG. 9). A printed circuit (PCB) board 44 is secured to the sensor module mounting portion and, in the illustrated embodiment extends radially inwardly (such as through an aperture in the structure of the outer casing) so that the PCB board is positioned a closely spaced and air gap separated distance from the rotary displaceable cam end profile of the component (FIGS. 4-5 and 6-7).

A pattern of linearly extending energizing and receiving coils, see at 46 and as is further depicted in FIG. 2, are disposed on the PCB (such exhibited along a longitudinal axis relative to a sensing direction of the electrically conducting and rotating or displacing component/coupler), the coils including both energizing coil inputs 48 and receiving coil outputs 50 and 52. The arrangement of coils depicted is non-limiting with the understanding that other patterns or configurations of coils can also be provided and which can include multiple looped portions which can translated into increased air gaps between the PCB and the electrically conducting cam or coupler profile to be measured.

The inductive sensor coils are aligned radially with respect to the axis of rotation of the cam profile, again either individual offset sections of arc 12, 14, 16 or continuous sloped at 18 and further described in the related variants of FIGS. 4-5 and 6-7, and by which rotational movement of the cam profile results in the cam surface moving linearly with respect to the position sensor, such again depicted by each of the linearly offsetting positions of arc segmented sections 14 and 16 in FIGS. 4-5, as well as the first and second rotated positions in FIGS. 6-7 of the sloping profile of varying circumferential thickness 18.

As is further generally known, the inductive sensor has a resonator which creates an oscillating signal which creates eddy currents in the receiving coils when the coils are coupled. As the coupler moves along the longitudinal axis of the coils, a reference voltage is measured. The reference voltage is proportional to the travel thus indicating the position of the coupler. This measurement is accomplished through the assistance of an ASIC (application specific integrated) chip 54 (again FIG. 1) incorporated into the PCB 44 which is in communication with the coils and which outputs a signal representative of a measure of the (rotational) displacement, such being a reference voltage proportional to the position of the rotary cam or linearly displacing profile thereby indicating the position selected by the driver.

The sensor module 10 in FIG. 1 further includes an upper housing 56 attachable to the base mounting portion 40 and which includes a plurality of pins 58, 60, 62 extending from the PCB and which are accessible from a plug receiving recess configured within an upper shroud 64 of the housing. The housing is mounted so that a predetermined airgap is maintained between the end profile cam surface (FIGS. 4-5 and 6-7) or circumferential outer surface (FIG. 9) of the electrically conductive displacing component and the surface of the coils exhibited upon the PCB. The separation (or air gap) is not seen in the plan views of FIGS. 4-5 and 6-7 however is shown at 66 in FIG. 8 and, in one non-limiting embodiment, can have an operational spacing of up to 4.5 mm.

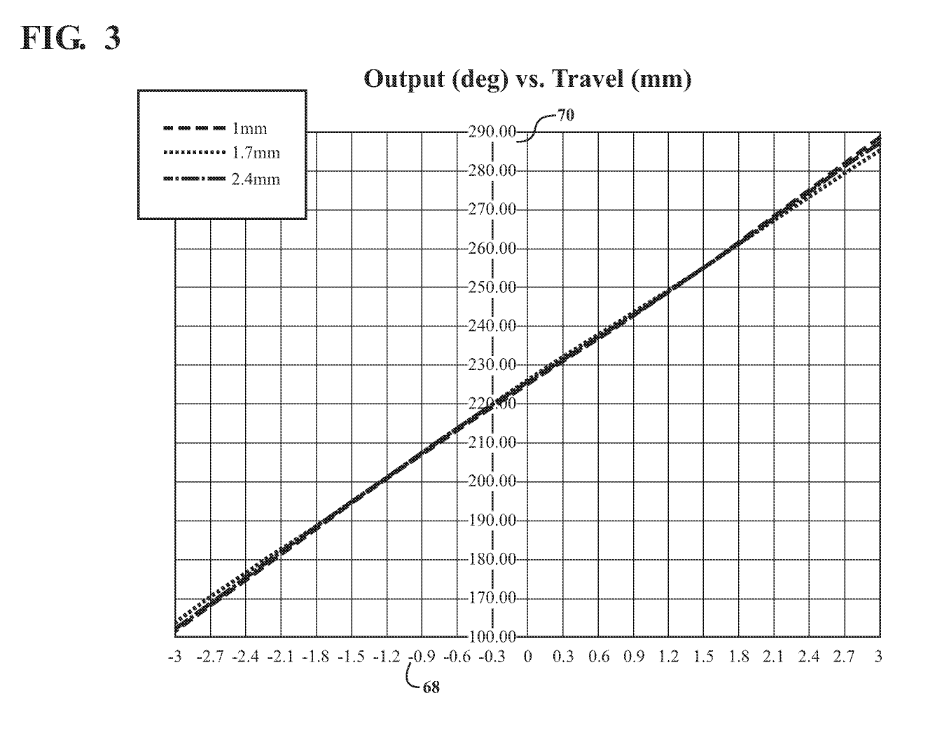

FIG. 3 is a graphical representation of rotational degrees, along an “x” axis 68, translated into linear units, along a “y axis” 70, corresponding to the rotational position or linear travel of the surface of the cam profile of FIGS. 4-5 and 6-7, relative to the coils on the PCB and for each of air gap spacings of 1 mm, 1.7 mm and 2.4 mm. This is again depicted by the corresponding linear displacement component of the segmented arc sections 14 and 16 in the illustrations of FIGS. 4-5 corresponding to the rotation of the cam profile relative to the PCB, as well as the corresponding linear displacement of the sloping profile of varying circumferential thickness 18 depicted in FIGS. 6-7 relative to the PCB coils.

Accordingly, the sensor module senses the rotational position of the cam profile (FIGS. 4-5 and 6-7) or linearly displacing component (FIG. 9). In the first embodiment, and since the rotation of the cam profile causes a change in the radial length of the circumference, a change in the rotational position of the cam causes a change in the radial length. The coils of the inductive are aligned radially with respect to the axis of rotation of the cam. Rotational movement of the cam results in the cam surface moving linearly with respect to the coils of the inductive position sensor (again shown in each of FIGS. 4-5 and 6-7) so as to create a reference voltage proportional to the position of the cam thereby indicating the position selected by the driver.

Consistent with the sensor module 10 described in FIG. 1, the sensor module 36 incorporates a similar PCB board with inductive coils, such as which is integrated into a main portion 72 of the module which seats within a recess in the outer transmission case (or other structure) 28 via an upper flange 74 which mounts to the exterior of the case. An upper shroud or the like 76 exhibits an access port for engaging terminal pins 78, 80 and 82 extending from the PCB. Although not shown, it is understood that the PCB in FIGS. 8-9 is arranged in a horizontal hidden fashion inside the lower confines of the main T case embedded portion 72 and so that the air gap 68 referenced (FIG. 8) separates the PCB from the raised circumferential electrically conducting surfaces (again 30 and 32) associated with the linearly shifting or displacing component 26.

Beyond the description of the invention with respect to a transfer case, it is understood that the position sensor can be used to measure the rotational location of other cam profiles, as well as used in other applications such as to measure the linear displacement of a locking collet or other coupling/decoupling mechanisms.

Having described my invention, other and additional preferred embodiments will become apparent to those skilled in the art to which it pertains, and without deviating from the scope of the appended claims:

I claim:

1. A position sensor assembly for use with a structure having a displacing electrically conducting component, said sensor assembly comprising:
a sensor module secured to the structure and supporting a printed circuit board exhibiting a plurality of inductive coils spaced from the component according to a separation gap; and
displacement of the component being sensed in a linear direction along said coils, causing a chip incorporated into said printed circuit board in communication with said coils to output a signal representative of a measure of the displacement.

2. The sensor assembly as described in claim 1, the displacing component further comprising a rotary displaceable component exhibiting a cam shaped end profile.

3. The sensor assembly as described in claim 2, said printed circuit board extending radially from said housing within the structure.

4. The sensor assembly as described in claim 2, said cam shaped end profile further comprising a sloping profile of varying circumferential thickness.

5. The sensor assembly as described in claim 2, said cam shaped end profile further comprising a stepped profile created by a plurality of discrete and successively offset sections of arc.

6. The sensor assembly as described in claim 2, the displacing component further comprising a linearly displaceable component exhibiting a circumferential conducting portion.

7. The sensor assembly as described in claim 1, further comprising a plurality of pins extending from said printed circuit board which are accessible from a plug recess configured within a housing covering said sensor module.

8. The sensor assembly as described in claim 1, said separation gap further comprising a distance of up to 4.5 mm.

9. A position sensor assembly for use with a structure having a rotary displacing electrically conducting component, said sensor assembly comprising:
a sensor module secured to the structure and supporting a printed circuit board exhibiting a plurality of inductive coils, said coils extending in a radial direction proximate to a cam shaped end profile of the component according to a separation gap; and
displacement of the component being sensed in a linear direction along said coils, causing a chip incorporated into said printed circuit board in communication with said coils to output a signal representative of a measure of the rotary displacement.

10. The sensor assembly as described in claim 9, said cam shaped end profile further comprising a sloping profile of varying circumferential thickness.

11. The sensor assembly as described in claim 9, said cam shaped end profile further comprising a stepped profile created by a plurality of discrete and successively offset sections of arc.

12. The sensor assembly as described in claim 9, further comprising a plurality of pins extending from said printed circuit board which are accessible from a plug recess configured within a housing covering said sensor module.

13. The sensor assembly as described in claim 9, said separation gap further comprising a distance of up to 4.5 mm.

14. A position sensor assembly for use with a structure having a linearly displacing electrically conducting component, said sensor assembly comprising:
a sensor module secured to the structure and supporting a printed circuit board exhibiting a plurality of inductive coils positioned proximate to a circumferential conducting portion of the linearly displacing component according to a separation gap; and
displacement of the component being sensed in a linear direction along said coils, causing a chip incorporated into said printed circuit board in communication with said coils to output a signal representative of a measure of the displacement.

15. The sensor assembly as described in claim 14, further comprising a plurality of pins extending from said printed circuit board which are accessible from a plug recess configured within a housing covering said sensor module.

16. The sensor assembly as described in claim 14, said separation gap further comprising a distance of up to 4.5 mm.
